(19) United States
(12) Patent Application Publication
(10) Pub. No.: US 2003/0197061 A1
(43) Pub. Date: Oct. 23, 2003

(54) Shopping system

(76) Inventor: Linda Din, Taichung Hsien (TW)

Correspondence Address: Alan D. Kamarth, Rider, Bennett, Egan & Arundel, LLP, Suite 2000, 333 South Seventh Street, Minneapolis, MN, 55402, US

(21) Appl. No.: 10/127,970

(22) Filed: Apr. 23, 2002

(51) Int. Cl. G06K 15/00

(52) U.S. Cl. 235/383

(57) ABSTRACT

An electronic shopping system is capable of integrating the sales, delivery and support functions for multiple separated electronic stores. Each one of these electronic stores provides a combination of over-the-counter and self-service merchandising. The self-service portion is accomplished by an assembly of multiple self-service automatic vending machines installed in front of the store. The over-the-counter portion is handled by one sales person, who is in a position to assist consumers trying to make a selection. All transactions are settled on a cashless basis through a sensor-controlled sales and payment processor, thus avoiding the risks associated with cash payment. The above-mentioned processor also has a telecom module to transmit all transactions data to a control center for a consolidated sales and inventory analysis.

### BACKGROUND OF THE INVENTION

1. Field of the Invention

The present invention relates to an electronic shopping system that is capable of integrating the sales, delivery and support functions for separated electronic stores. Each one of these electronic stores provides a combination of over-the-counter and self-service merchandising. All transactions are settled on a cashless basis with sales and payment processors that are respectively installed at checkout counters and in automatic vending machines. The processor also has a telecom module to transmit all transaction data back to the control center for consolidated sales and inventory analysis in the system.

2. Description of Related Art

Merchandise can be purchased by consumers through a physical distribution channel or a virtual channel. The former is usually a conventional channel, but the latter is through electronic media. Consumers using a virtual channel can take advantage of on-line shopping and merchandising facilities by logging onto commercial web sites. Modern consumers prefer the virtual channel because it saves time, they can select items to purchase and place orders by means of step-by-step instructions shown on the monitor, and the articles they order can be delivered to their homes. However, physical purchase of commodities is still widely practiced in our society. The main advantage is that consumers do not need to worry about network security as they do in electronic shopping, and plus the fact that the quality of the physical commodity can be carefully inspected before a purchase.

In a conventional transaction involving a physical commodity, a consumer goes into a store, selects one or more items to buy and takes the item or items to the checkout counter. The most used methods of completing the transaction are cash payment or payment by credit card. Furthermore, most shop owners must make routine stock counts to find out what items need to be restocked and how many of each item are left in the store so the inventory can be brought up to date.

However, this conventional merchandising by cash or credit cards has drawbacks. The frequent interaction between a shop owner and consumers entails considerable transaction risks. The shop owner is likely to suffer financial losses such as inadvertently taking counterfeit money or accepting payment with stolen or bogus credit cards.

Another commonly used physical distribution channel is automatic vending machines. Coin-operated or credit card vending machines used in the past often failed to distinguish good from bad coins, and sometimes the machines could be jammed by foreign objects. The owner of the vending machines respectively suffered a loss or was required to repair the machines.

Considering the problems with coin-operated vending machines, a type of vending machine with cash cards was invented to replace coin-operated machines. The machine used cash cards that have information coded on a magnetic stripe. The cash card has to be inserted into the machine through a card insertion slot in the automatic vending machine to read the necessary information encoded on the magnetic stripe, including the cash balance on the card owner. If the cash card was verified, an amount equal to the purchase price was then deducted from the card. Using this method, the merchant accepting the cash card is protected against counterfeit money, but the cash card has other shortcomings including those that follow.

(1). Wear and tear: Since the machine has to take in the card to read the encoded information, the magnetic stripe is subject to frequent scrapping as it is inserted into and ejected from the card slot and could be damaged. As a result, the encoded information may be lost or corrupted.

(2). High maintenance cost: Just like coin-operated machines, these fully independent vending machines need to be set up at strategic points such as commercial districts, roadsides, school districts and corporate buildings where large numbers of potential consumers pass every day. Since these machines are separated over a large territory, service personnel have to be dispatched regularly to check their stock and the operating condition of the automatic vending machines to find out whether they are in normal operating condition or damaged by unlawful breakage or normal wear. With all these possibilities, to keep the operation running smoothly and to restock their merchandise, the management of separated vending machines is an awesome task. Many field personnel are required to service all these separated machines. Hence, the operating cost for such an operation is significantly large.

(3). No continuous status monitoring and instantaneous notification of a fault status: Service personnel are only able to check the status of each machine once every couple of days. If the machine breaks or the stock runs out on a day between routine service calls, the service person is not in a position to detect the irregularity until day of the regular service call. Therefore some potential business may be lost as a result of this.

Considering the various problems with the physical transaction of commodities, the present invention provides an electronic shopping system that uses a sales and payment processor to conduct cashless shopping and merchandising in friendly convenient stores and avoid the risks with respect to cash transactions.

### SUMMARY OF THE INVENTION

The main objective of an electronic shopping system in accordance with the present invention is to provide an electronic shopping system that is capable of integrating sales, delivery and support functions for separated electronic stores, wherein each store provides a combination of over-the-counter and self-service merchandising. Through the communication capability of the sales and payment processor, the system is able to collate all transaction data from separated electronic stores, without large numbers of service personnel so the sales and inventory administration for the integrated system can be effectively enhanced.

Another objective of the present invention is to provide an electronic shopping system that allows the consumers to purchase goods even when the electronic store is closed. Further, the present invention uses the contactless chip care to create a universal cashless system.

Other objectives, advantages, and novel features of the invention will become apparent from the detailed description when taken in conjunction with the attached drawings.

### BRIEF DESCRIPTION OF THE DRAWINGS

FIG. 1 is a perspective view of the outside of an electronic store in accordance with the present invention;

FIG. 2 is a perspective view of the inside of the electronic store in FIG. 1;

FIG. 3 is a functional block diagram of the sales and payment processor used in the electronic store in FIG. 1;

FIG. 4 is a functional block diagram of the process of placing an order through the sales and payment processor used in the electronic store in FIG. 1;

FIG. 5 is a system layout of the sensor-controlled sales and payment processor; and

FIG. 6 is a conceptual diagram of the entire electronic shopping system.

### DETAILED DESCRIPTION OF THE PREFERRED EMBODIMENT

The present invention is an electronic shopping system that is capable of integrating the sales, delivery and other services for multiple separated electronic stores. The services provided in one of these electronic stores (1) can be divided into over-the-counter and self-service merchandising portions.

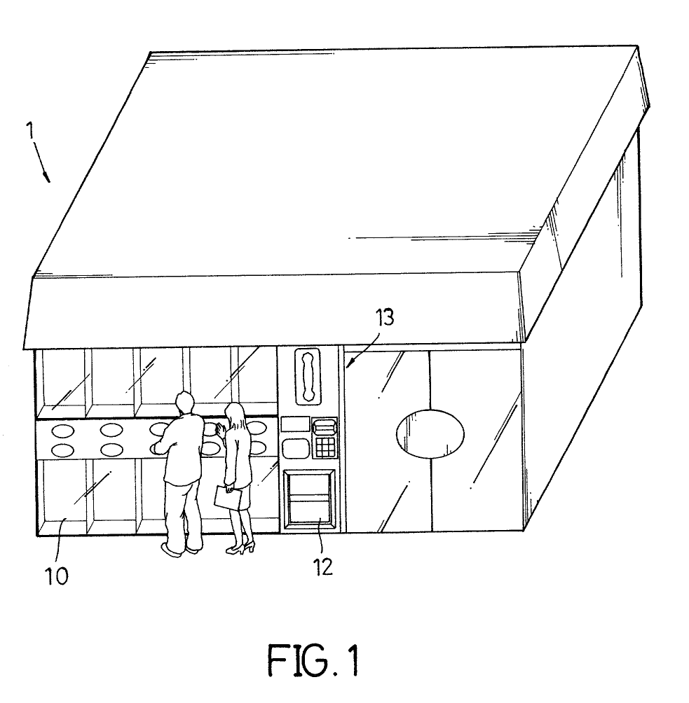

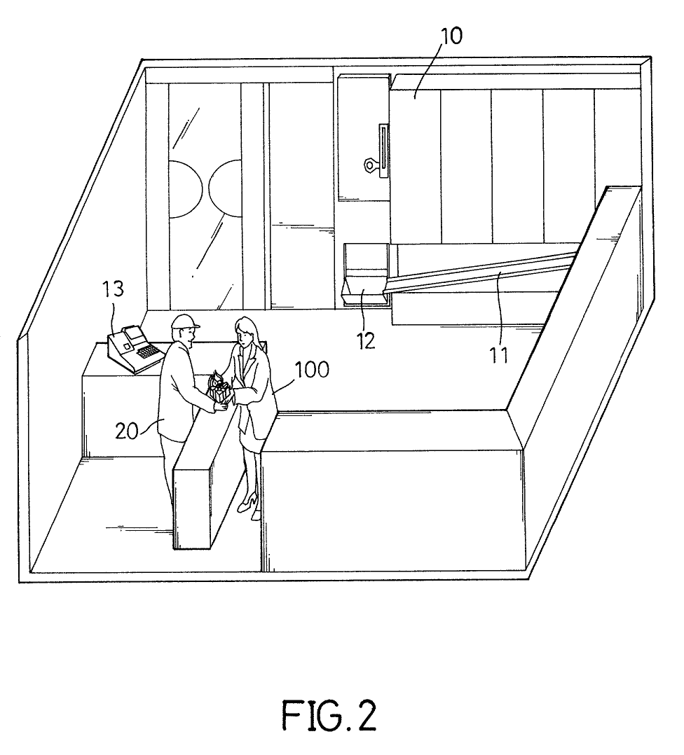

With reference to FIGS. 1 and 2, self-service merchandising is accomplished through an assembly of automatic vending machines (10) lined up in front of an electronic store (e-store). Each automatic vending machine is stocked with various kinds of merchandise with packaging that meets specifications for the vending machine. Items displayed include drinks, cigarettes, music/movie CDs, processed foods and other consumer items. When a consumer makes his or her selection, the article(s) selected will drop down to a sliding conveyor (11) at the bottom of the automatic vending machines and be transported to a pickup bin (12). The consumer (100) only has to reach in and take the article(s) from the pickup bin (12).

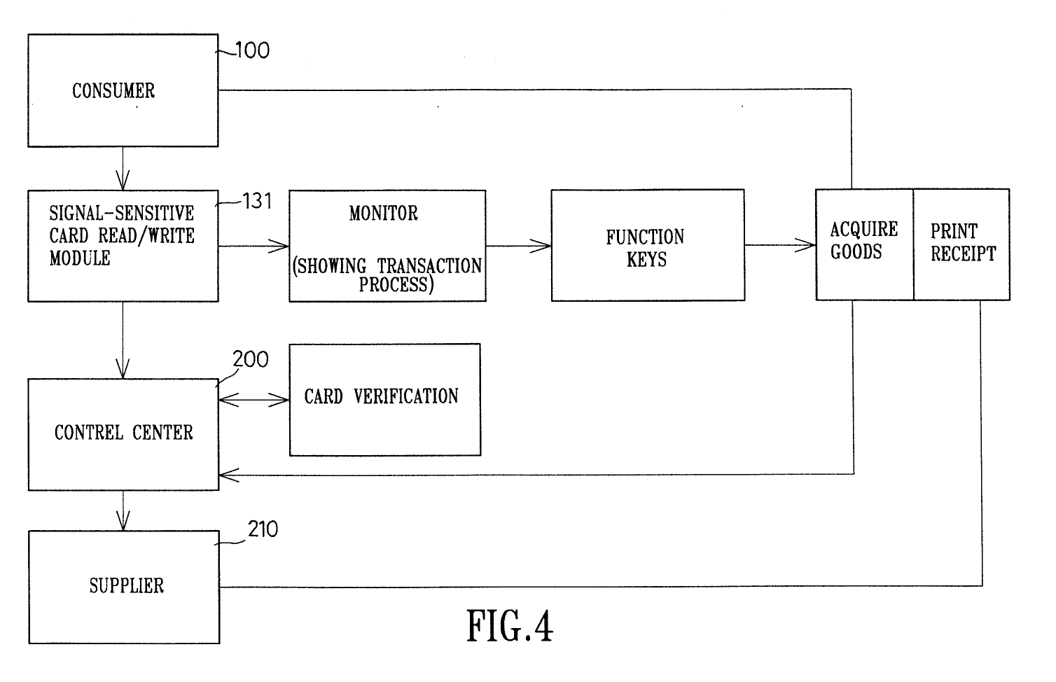

A sales and payment processor (not shown) installed in an over-the-counter checkout register (16) inside the electronic store and the automatic vending machines (10). A customer carries out a transaction by following the instructions presented on a display (not numbered) on the sales and payment processor (13) will show step-by-step transaction procedures depicted in FIG. 4.

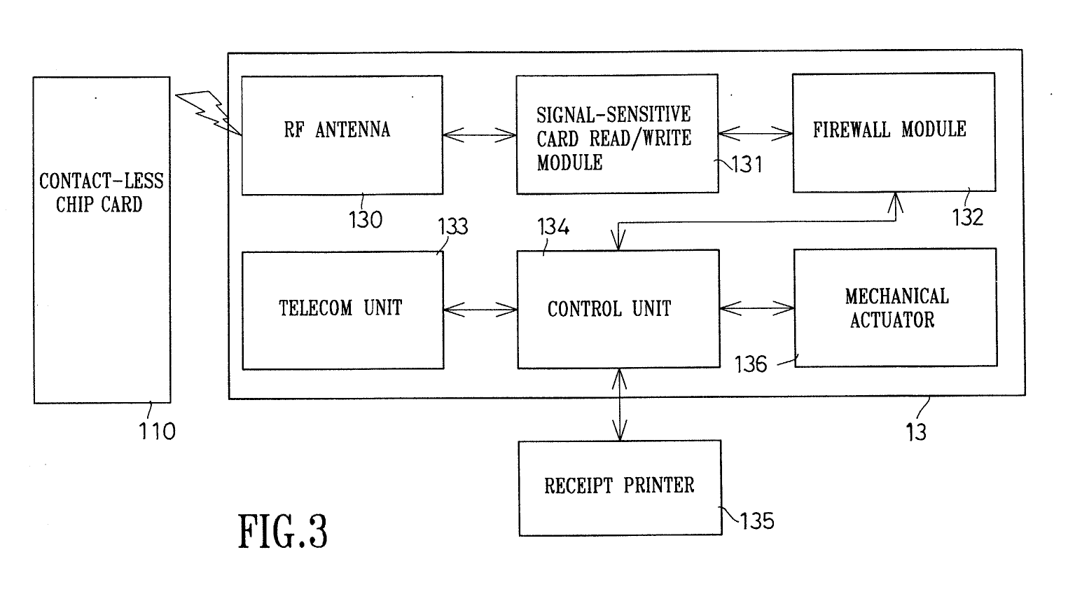

With reference to FIGS. 3 and 4, the sales and payment processor (13) comprises an RF antenna (130), a firewall module (132), a mechanical actuator (136), a signal-sensitive card read/write module (131), a telecom module (133) and a control unit (134). The RF antenna (130) establishes read/write communications with data on a contactless chip card (110). The signal-sensitive card read/write module (131) reads from and writes to the contactless chip card (110) in association with the value saved on the card. The firewall module (132) is connected between the signal-sensitive card read/write module (131) and a control unit (134) that authenticates the contactless chip card (110) presented by the consumer. The telecom module (133) transmits the read/write data between the signal-sensitive card read/write module (131) and a control center (200) for verifying a chip card (110) and also for sending back the transaction data at regular intervals. The control unit (134) authenticates the contactless chip card (110) presented by the consumer (100) through the data link to an on-line database in the control center (200), and to activate a receipt printer (135). The mechanical actuator (136) is connected to the control unit (134) and actuates the article release mechanism (not shown) in the automatic vending machine (10).

Before the consumer (100) can utilize the electronic shopping system, he or she first has to purchase a contactless chip card (110) that has a cash value stored on the card. When the consumer (100) selects an article, he or she inputs a key combination to select the item, these input data are then transmitted to the control unit (134) which computes the total cost for the selected articles.

With reference to FIG. 3, the consumer (100) using the chip card to pay for the articles selected only has to place the contactless chip card in the signal reception area (not numbered) on the sales and payment processor (13). The RF antenna (130) then senses the presence of the contactless chip card (110) and establishes a communication link between the signal-sensitive card read/write module (131) and the contactless chip card (110). The signal-sensitive card read/write module (131) reads the data on the contactless chip card (110). After completing the card read operation, the data is passed to the firewall module (132) for a series of authentication and identification checks to prevent the use of imitation or invalid cards. If the card is valid and the account balance is adequate to cover the purchase, the amount of the purchase is deducted from the existing balance. A new balance will be written on the contactless chip card (110) by the signal-sensitive card read/write module (131) through the RF antenna (130). The control unit (134) then activates the receipt printer (135) to print out a sales receipt for the consumer. The transaction data is passed through the telecom module (133) to the control center (200) and prints a transaction report in the control center (200).

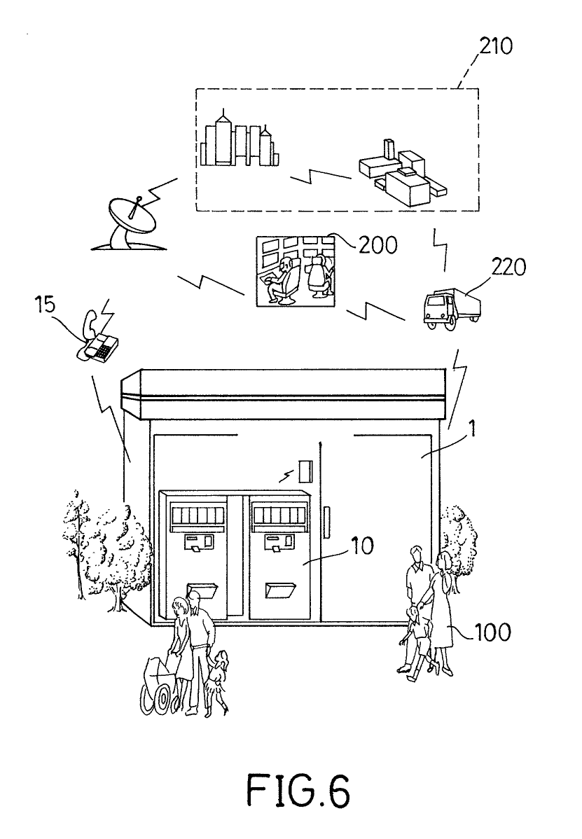

With further reference to FIG. 6, the communications module (133) is loaded with communication software to transmit the sales data to the control center (200) at regular intervals. The control center (200) is then able to inform the merchandise supplier (210) when to replenish the stock in each and every electronic store (1), therefore realizing automation in sales and inventory management.

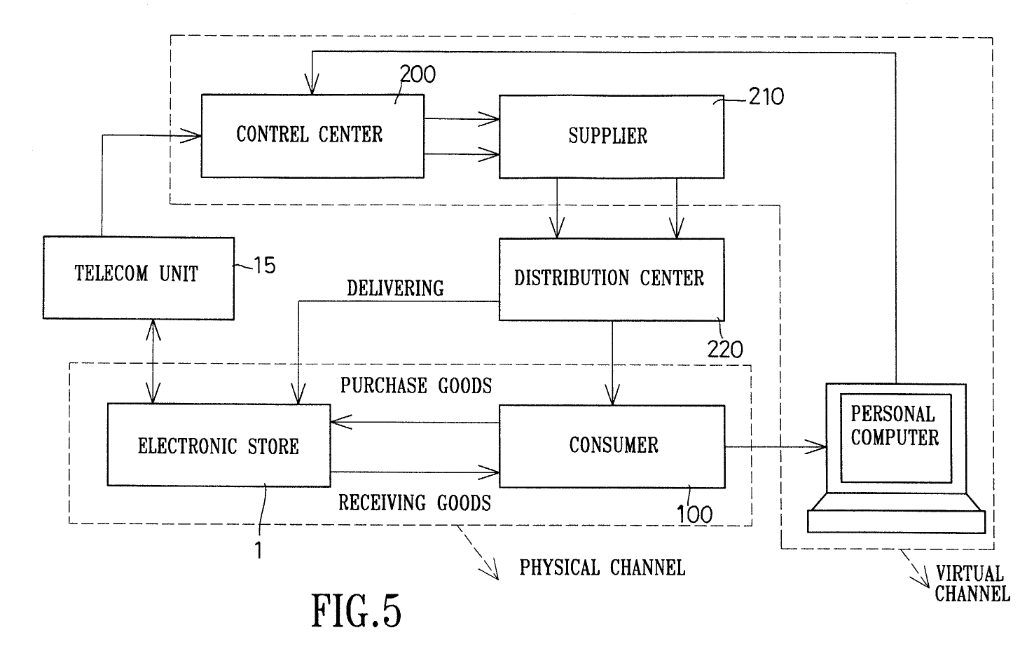

With further reference to FIG. 5, the communications module (133) is linked to a telephone (15). When the communications module (133) is not engaged in transmitting sales data, the telephone (15) serves as a public phone for use by consumers (100). Consumers may access the telephone through the same method previously described for automatic vending machines (10). The consumer (100) only has to present the contactless chip card (110) in front of the sales and payment processor (13) to enable the dialing mode, and the telephone charges will be deducted from the chip card (110).

With reference to FIG. 2, over-the-counter merchandising is supported by service personnel (20) stationed in the electronic store (1), who can assist walk-in consumers in their shopping and provide checkout service. The mark-up for articles put on the display racks of the electronic store are higher than those in the vending machines, since these articles are too large to be accommodated in the vending machines (10). When a consumer (100) selects one of these articles, he or she brings it to the service personnel (20) at the check out counter. There is an over the counter register (16) that has the same sales and payment processor (13) used in the automatic vending machines (10). Through an internal sensor (not shown) in the processor, the signal-sensitive card read/write module (131) deducts the amount of purchase from the account balance saved on the chip card (110), and the receipt printer outputs a receipt for the consumer. The sales and payment processor (13) is also equipped with a communications module (133) for transmitting the sales data to the control center (200).

With reference to FIGS. 5 and 6, the telecom module (133) of the sales and payment processor incorporated in the checkout register (16) and automatic vending machines (10) is establishes a data link between the electronic store (1) and the control center (200). The control center (200) then obtains the latest information with respect to the stock level of the merchandise in the electronic store (1). After the control center (200) collates all transaction data from separated electronic stores (1), it may initiate a delivery by calling the merchandise supplier (210) to request replenishment of the articles in short supply based on the sales data received from all the electronic stores (1). The merchandise will be delivered to the destinations by merchandise distribution centers (220). A similar procedure is used to dispatch merchandise ordered through the virtual channel from the merchandise distribution center (220) to the consumers (100).

Consumers (100) choosing to use the virtual channel may use a personal computer to establish a communication link with a server (not shown) in the control center (200), select articles from an on-line catalog, and place orders electronically. When the control center (200) receives the order, the control center (200) prepares the article(s) selected through the supplier (210) and arranges to have the distribution center (220) delivered the articles to the consumer's (100) home to conclude the transaction.

The electronic shopping system has the following merits:

(1). Reduced risks: Since the transactions are concluded on a cashless basis by means of chip cards, users are protected against the use of counterfeit money, larceny or burglary of cash.

(2). Reduced Costs: Thanks to the system integration of the virtual and physical channels, the operating costs and overhead costs for sales and management can be streamlined. By means of data transmission through the communications module (133) at regular intervals, sales data from the separated electronic stores (1) can be collated by the control center (200) for consolidated sales and inventory analysis. The control center (200) will then be able to find out the collective stock status and determine when to restock the merchandise. The system therefore obviates the need for regular visits to all the electronic stores (1) to take the physical inventory. The system helps cut down the operation manpower and improve the system efficiency.

(3). Contact-free signal sensing: The method employed to sense the presence of a chip card by the sales and payment processor is different from all conventional methods. It reads the account information saved on a contactless chip card (110) and then writes a new balance to complete a transaction without physical contact with the chip card (110). This new design can prevent abrasion of magnetic stripes, which cause poor data recording on the magnetic stripes.

The foregoing illustration of the preferred embodiments of the present invention is intended to be illustrative only, under no circumstances should the scope of the present invention be so restricted. The present invention in possession of those merits mentioned above is clearly superior to the conventional systems.

What is claimed is:

1. An electronic shopping system comprising:
an electronic store providing a combination of over-the-counter and self-service merchandising, whereby the self-service portion is accomplished by more than one automatic vending machine assembled in front of the store, and the over-the-counter portion is handled by service personnel inside the store, and all transactions are settled on a cashless basis through a sensor-controlled sales and payment processor;
a communications module installed inside the sensor-controlled sales and payment processor that transmits the sales data from the electronic store to the control center;
a control office which is able to monitor the sales condition of the merchandise through the data link with separated electronic stores; and
a merchandise supplier which is able to obtain the stock status with respect to merchandise through the data link with the control center and determine the timing for delivery;
whereby a consumer walks into the electronic store to shop for various articles, carrying a contactless chip card; the person then picks an article to purchase either from the display racks inside the store or one of the automatic vending machines; the person then uses the value saved on the chip card to pay for the article, and the purchase amount is then deducted from the previous account balance to conclude the transaction.

2. An electronic shopping system as claimed in claim 1, wherein the sensor-controlled sales and payment processor comprises:
an RF antenna responsible for establishing the data communication with the contactless chip card presented by the consumer;
a signal-sensitive card read/write module through the RF antenna responsible for reading/writing from/to the contactless chip card with respect to the value saved inside the card; and
a firewall module connected between the signal-sensitive card read/write module and a control unit responsible for authenticating the contactless chip card presented by the consumer.

3. An electronic shopping system as claimed in claim 2, wherein the telecom module is equipped with a telephone set, which can be used by consumers for dialing out.

4. An electronic shopping system as claimed in claim 3, wherein the bottom of the automatic vending machines is affixed with a conveyor, which moves the article selected by the consumer to the pickup bin for picking up.
